(19) United States
(12) Patent Application Publication
(10) Pub. No.: US 2013/0126678 A1
(43) Pub. Date: May 23, 2013

(54) SPACE VEHICLE RENDEZVOUS

(71) Applicant: Richard Bruce ROMNEY, JR., Phoenixville, PA (US)

(72) Inventor: Richard Bruce ROMNEY, JR., Phoenixville, PA (US)

(73) Assignee: LOCKHEED MARTIN CORPORATION, Bethesda, MD (US)

(21) Appl. No.: 13/534,761

(22) Filed: Jun. 27, 2012

Related U.S. Application Data
(60) Provisional application No. 61/563,259, filed on Nov. 23, 2011.

(51) Int. Cl. B64G 1/26

(52) U.S. Cl. 244/172.4

(57) ABSTRACT

A method and apparatus provide for a basket of passively-safe thruster-burn positions within a context of rendezvous between a space-vehicle and a resident-space-object while in orbit around the Earth, for example. The basket of positions is defined by an intersection of a plurality of half-spaces determined based on a keep-out-zone associated with the resident-space-object, and a nominal position of the space-vehicle. The plurality of half-spaces defines a corresponding plurality of half-space boundary conditions within which the basket of positions is disposed. When a position of the space-vehicle is within the basket of positions at a time of a scheduled thruster-burn, then the scheduled thruster-burn is ensured to result in passive-safety.

This is a Non-Provisional application which claims the priority benefit of U.S. Provisional Application No. 61/563,259 filed on Nov. 11, 2011, having Bruce Romney as the sole named inventor. The U.S. Provisional Application No. 61/563,259 is hereby incorporated by reference in its entirety.

### BACKGROUND

Space vehicles are frequently sent into space to rendezvous with resident-space-objects such as satellites or space stations. Rendezvous operations require careful consideration to achieve safety requirements.

### SUMMARY

A method and apparatus are disclosed that provide passively-safe thruster-burn positions of a space-vehicle (a basket of positions) within the context of rendezvous between the space-vehicle and a resident-space-object while in orbit around the Earth, for example. The basket of positions is defined by an intersection of a plurality of first half-spaces determined based on a keep-out-zone (KOZ) associated with the resident-space-object, and a nominal position of the space-vehicle. The plurality of first half-spaces defines a corresponding plurality of first half-space boundary conditions within which the basket of positions is disposed. When a detected position of the space-vehicle is within the basket of positions at a time of a next scheduled thruster-burn, then the next scheduled thruster-burn is passively-safe, i.e., the space-vehicle is ensured to avoid the keep-out-zone of the resident-space-object in the presence of space-vehicle system uncertainties, and even if a space-vehicle system failure prevents all subsequent maneuvers.

A rendezvous plan may include thruster-burns at selected nominal positions of the space-vehicle and send the space-vehicle along a nominal flight path (trajectory). The nominal position of the space-vehicle is one of many positions that are part of the rendezvous plan between the space-vehicle and the resident-space-object. Due to various sources of possible errors, the space-vehicle proceeds along a trajectory that may have positions and velocities which differ from the nominal positions and velocities. These, position and velocity differences are accounted for by adjusting a next scheduled thruster-burn so that space-vehicle is set on a passively-safe trajectory toward a next nominal position.

Before the space-vehicle reaches a position for the next scheduled thruster-burn, the detected position and velocity of the space-vehicle may be obtained from sensors either onboard the space-vehicle or as part of a ground-station, propagated to a time of the next scheduled thruster-burn, and the propagated position checked against the basket of positions. This checking process is performed by confirming that a set of inequalities associated with the first half-space boundary conditions is satisfied by the propagated position. If any of the inequalities are not satisfied but the time for the scheduled thruster-burn has not yet arrived, then a warning signal may be issued that passive-safety may not be assured. If any of the inequalities are not satisfied and the time for the scheduled has arrived, then a signal is issued that rejects the next scheduled thruster-burn. If all the inequalities are satisfied at the time for the next scheduled thruster-burn, then the next scheduled thruster-burn is executed because passive-safety is ensured.

The first half-space boundary conditions are generated based on a portion of a plurality of second half-space boundaries that are identified to be points on a convex hull in a dual-space. Each of the second half-space boundary conditions corresponds to a plane that is tangential to the KOZ and perpendicular to a vector between a nominal position of the space-vehicle and a center of the KOZ. The plane defines a new KOZ (NKOZ). One NKOZ(tᵢ) is defined for each nominal position of the space-vehicle, for i=1, 2, . . . n. Each i is associated with a moment in time following a thruster-burn. A set of second half-spaces may be calculated as inequalities based on the corresponding NKOZ(tᵢ), the nominal position of the space-vehicle at time maximum values of various error parameters related to a position and a velocity of the space-vehicle, and maximum values of control errors associated with a thruster-burn such as a direction and a magnitude of the thruster-burn.

All second half-spaces corresponding to nominal positions propagated for times up to a maximum elapsed time T from the next scheduled thruster-burn are mapped as points in the dual-space. A convex hull of all the points in the dual-space may be formed to select second half-spaces that correspond to points on the convex hull. Second half-space boundary conditions corresponding to the selected second half-spaces are identified to be the first half-space boundary conditions.

Although the above discussion relates to adjusting the next scheduled thruster-burn to correct position and velocity errors, a similar process may be implemented if adjustments to a previous scheduled thruster-burn are not made, but a nominal scheduled thruster-burn is executed. A basket of positions may be defined for a next scheduled thruster-burn that ensures passive-safety in-spite-of deviations from the planned rendezvous.

### BRIEF DESCRIPTION OF THE DRAWINGS

Exemplary embodiments are described in detail below with reference to the accompanying drawings wherein like numerals reference like elements, and wherein:

FIG. 1 shows an exemplary diagram of a resident-space-object in orbit around the Earth;

FIG. 2 shows an exemplary diagram of a space-vehicle in a rendezvous operation with the resident-space-object;

FIG. 3 shows an exemplary diagram of planned and actual positions of the space-vehicle for a next scheduled thruster-burn;

FIG. 4 shows an exemplary diagram of position vectors of the space vehicle with respect to the resident-space-object;

FIG. 5 shows an exemplary diagram of possible thruster-burn error;

FIG. 6 shows an exemplary diagram of mapping from real-space to dual-space;

FIG. 7 shows an exemplary diagram of points in dual-space that are on a convex hull;

FIG. 8 shows a diagram of an exemplary rendezvous control apparatus; and

FIG. 9 shows an exemplary flow chart of the rendezvous control apparatus.

### DETAILED DESCRIPTION OF EMBODIMENTS

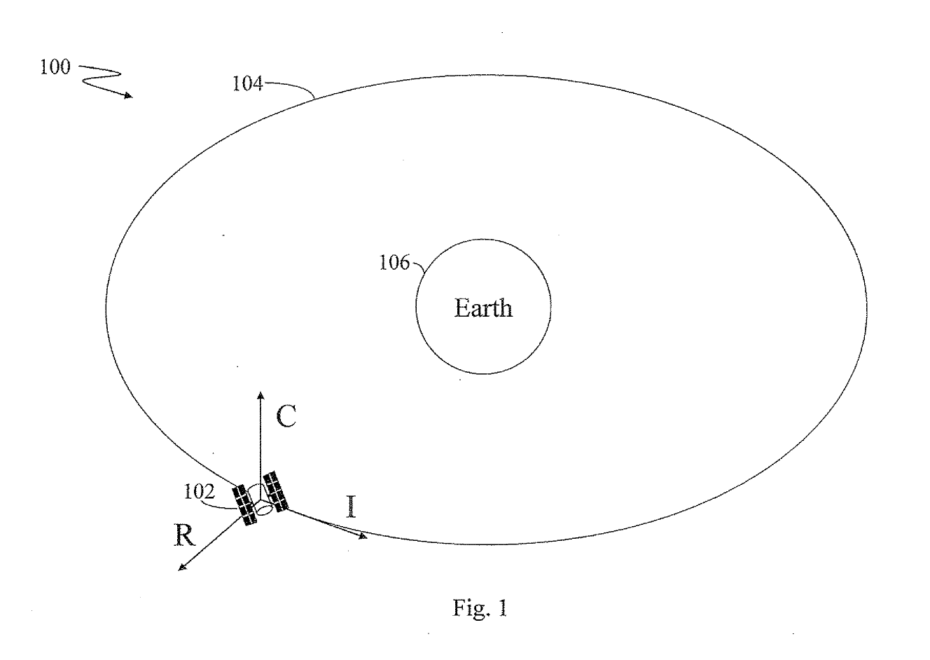

FIG. 1 shows an exemplary diagram 100 of a resident-space-object 102 in an orbit 104 around Earth 106. For rendezvous purposes, a radial/in-track/cross-track (RIC) coordinate system is centered on resident-space-object 102. The RIC coordinate system has an R-axis which points away from Earth 106, a C-axis which points in a direction of an angular velocity vector of resident-space-object 102 in orbit 104, and an I-axis which points along a velocity vector of resident-space-object 102 for a circular orbit.

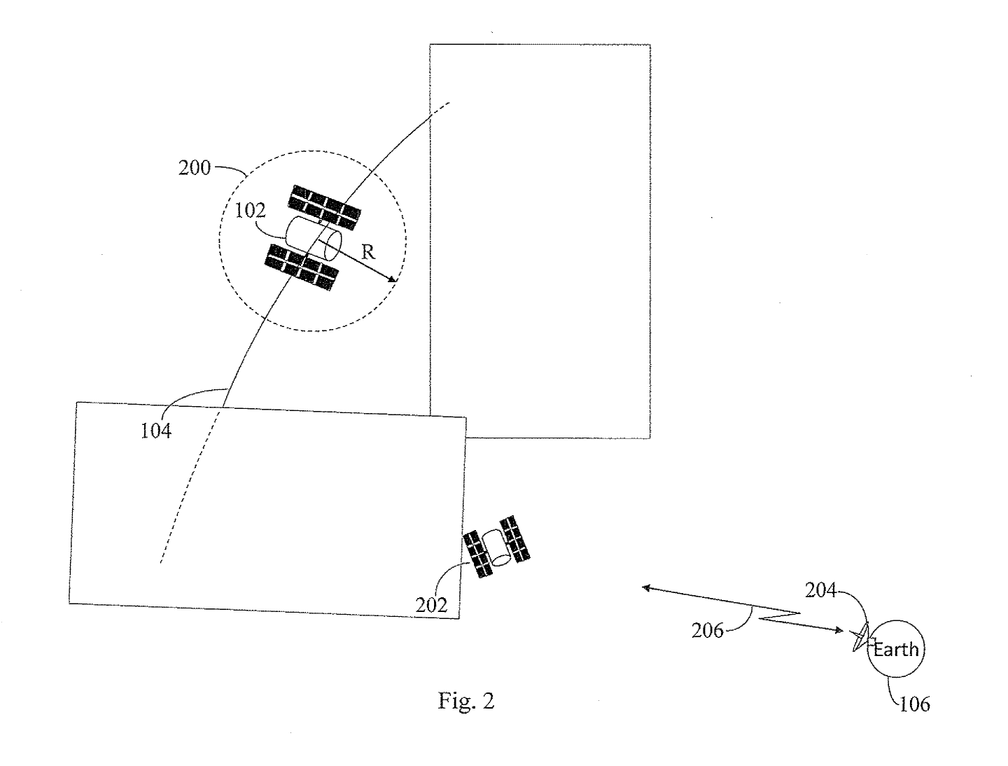

FIG. 2 shows a keep-out-zone (KOZ) 200 such as a sphere, for example, for resident-space-object 102 having a radius R. KOZ 200 may be a surface surrounding resident-space-object 102 that other space-objects such as a space-vehicle 202 must not penetrate so that safety or an operation of resident-space-object 102 may not be compromised.

Space-vehicle 202 is shown being controlled by a ground-station 204 via communication link 206. Onboard sensors or ground-station sensors may detect a position and a velocity of space-vehicle 202, for example. Onboard sensor information may be transmitted back to ground-station 204 for processing to control space-vehicle 202 to rendezvous with resident-space-object 102. Although ground-station 204 is used as an example, space-vehicle 202 may implement ground-station functions onboard and may control the rendezvous with resident-space-object 102 on its own.

When a rendezvous is planned between space-vehicle 202 and resident-space-object 102 for example, flight paths (trajectories) and thruster-burns are usually planned ahead of time so that passive-safety is maintained at all times. A thruster-burn is defined by burn-parameters that include a burn position, a pre-burn velocity, a thruster-burn magnitude and a thruster-burn direction. Passive-safety is maintained when space-vehicle 202 does not penetrate KOZ 200 even if space-vehicle 202 makes no further thruster-burns and becomes a passive object like a rock for a specified duration of time. Thus, KOZ 200 is a boundary condition for flight positions of space-vehicle 200. A desired position and a desired velocity of space-vehicle 202 just prior to each scheduled thruster-burn are calculated for a complete rendezvous operation. The desired positions and desired velocities prior to all scheduled thruster-burns are identified as nominal positions and nominal velocities. A scheduled thruster-burn includes a time for a thruster-burn in addition to the burn-parameters noted above.

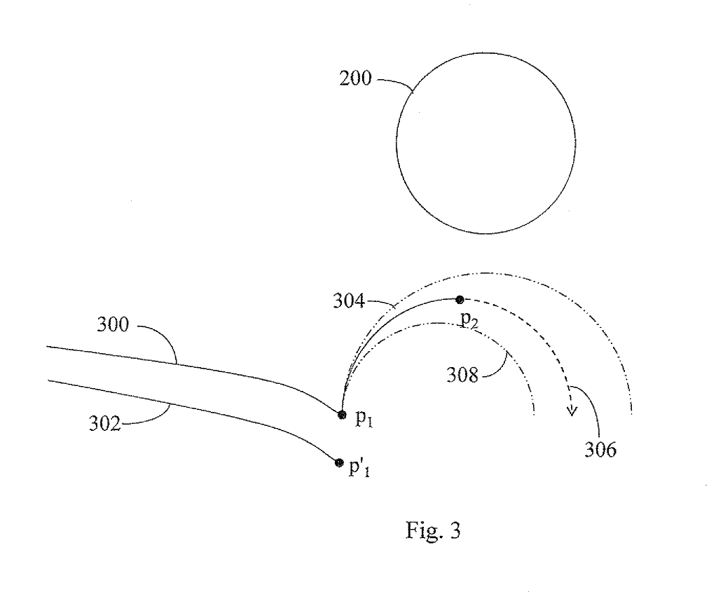

FIG. 3 shows KOZ 200 and various positions of space-vehicle 202. A nominal position, p₁, of space-vehicle 202 is calculated based on the rendezvous plan after a previous thruster-burn sending space-vehicle 202 along a nominal trajectory 300. A nominal position, p₂, is calculated for space-vehicle 202 along trajectory 306 after a scheduled thruster-burn at p₁. Trajectory 306 appears curved because space-vehicle 202 is in an orbit around Earth 106 and the RIC coordinate frame is non-inertial. If the space-vehicle 202 is actually at position p₁, then, the scheduled thruster-burn at p₁ would place space-vehicle 202 at nominal position p₂ after a nominal time. However, due to uncertainties of the scheduled thruster-burn and uncertainties of position p₁ and nominal velocity at p₁, space-vehicle 202 could possibly be placed on other trajectories such as trajectories 304 or 308.

In fact, due to various unforeseeable situations such as discussed above, FIG. 3 shows that space-vehicle 202 actually had trajectory 302 and arrived at position p′₁ instead of p₁ and had a different velocity than a planned nominal velocity after the previous thruster-burn. Thus, because the actual position and velocity of space-vehicle 202 are not as planned, it is necessary to ensure that a trajectory resulting from a next thruster-burn maintains passive-safety in connection with KOZ 200.

A position and a velocity in time of an object in orbit which is in proximity to another object in orbit are given by Hill's Equation which is as follows:

$$( \begin{matrix}r ( t ) \\ i ( t ) \\ c ( t ) \\ \dot{r} ( t ) \\ \dot{i} ( t ) \\ \dot{c} ( t )\end{matrix} ) = ( \begin{matrix}4 - 3 cos ω t & 0 & 0 & ( sin ω t / ω ) & 2 ( 1 - cos ω t ) / ω & 0 \\ 6 ( ( sin ω t ) - ω t ) & 1 & 0 & 2 ( cos ω t - 1 ) / ω & ( 4 ( sin ω t ) / ω ) - 3 t & 0 \\ 0 & 0 & cos ω t & 0 & 0 & ( sin ω t ) / ω \\ 3 ω sin ω t & 0 & 0 & cos ω t & 2 sin ω t & 0 \\ 6 ω ( ( cos ω t ) - 1 ) & 0 & 0 & - 2 sin ω t & 4 ( cos ω t ) - 3 & 0 \\ 0 & 0 & - ωsin ω t & 0 & 0 & cos ω t\end{matrix} ) ( \begin{matrix}r ( 0 ) \\ i ( 0 ) \\ c ( 0 ) \\ \dot{r} ( 0 ) \\ \dot{i} ( 0 ) \\ \dot{c} ( 0 )\end{matrix} ) , \qquad ( 1 )$$

where ω is the orbital angular velocity and \dot{r}(t), \dot{i}(t), and ċ(t) are first derivatives of the position. Thus, \dot{r}(t), \dot{i}(t), and ċ(t) represent a velocity \vec{v}(t). H(t) is a matrix that relates a position and velocity in time relative to a starting position and velocity.

Hill's Equation above includes both linear and non-linear elements and is very difficult to solve for a time that meets some condition such as a closest approach. However, by

1) defining a different boundary condition other than KOZ 200 to form a new KOZ (NKOZ) that subsumes KOZ 200,
2) setting maximum bounds of possible deviations in position, velocity, thruster-burn magnitude, and thruster-burn direction, and
3) making some reasonable approximations relating to thruster-burn deviations, Hill's Equation can be used to derive a set of linear inequalities that define a basket of positions at which a thruster-burn could be executed that results in passive-safety relative to KOZ 200.

The matrix in Hill's equation can be decomposed into four 3×3 sub-matrices as follows:

$$H ( t ) = ( \begin{matrix}{H}_{11} ( t ) & {H}_{12} ( t ) \\ {H}_{21} ( t ) & {H}_{22} ( t )\end{matrix} ) .$$

In the following discussion, a subscript “nom” indicates a nominal value that is a calculated value based on a planned trajectory of space-vehicle 202. If \vec{p}ₙₒₘ(t) is a nominal position vector having rₙₒₘ(t), iₙₒₘ(t), and cₙₒₘ(t) components in the RIC coordinate system centered on resident-space-object 102, and \vec{v}ₙₒₘ(t) is a nominal velocity vector having \dot{r}ₙₒₘ(t), \dot{i}(t), and ċₙₒₘ(t) components, then the nominal position and velocity vectors at time t starting from position \vec{p}₁ and velocity \vec{v}₁ vectors are as follows:

$$( \begin{matrix}{\vec{p}}_{nom} ( t ) \\ {\vec{v}}_{nom} ( t )\end{matrix} ) = ( \begin{matrix}{H}_{11} ( t ) & {H}_{12} ( t ) \\ {H}_{21} ( t ) & {H}_{22} ( t )\end{matrix} ) ( \begin{matrix}{\vec{p}}_{1} \\ {\vec{v}}_{1}\end{matrix} ) .$$

At time τ after a thruster-burn at p₁, pₙₒₘ becomes p(τ) which we now designate to be p₂, and \vec{p}₂=H₁₁(τ)\vec{p}₁+H₁₂(τ)\vec{v}₁⁺, where \vec{v}₁⁺ is the velocity of space-vehicle 202 immediately after the thruster-burn. It follows then that a nominal departure velocity is \vec{v}₁⁺ₙₒₘ(t)=H₁₂⁻¹(τ)[\vec{p}₂(t)−H₁₁(τ)\vec{p}₁]. If \vec{v}₁⁻ₙₒₘ is the velocity of space-vehicle 202 just before the thruster-burn at p₁ (pre-burn velocity), then a thruster-burn at p₁ to get to p₂ would apply the following change in velocity: \vec{b}ₙₒₘ=\vec{v}₁⁺ₙₒₘ−\vec{v}₁⁻ₙₒₘ.

However, space-vehicle 202 may not have arrived at p₁ as specified in the planned rendezvous, but actually arrived at p₁ₙₒₘ+Δp and a pre-burn velocity of \vec{v}₁⁻ₙₒₘ(t)+Δ\vec{v}₁⁻. Based on this knowledge, the planned rendezvous can be recovered by readjusting a next scheduled thruster-burn for a new re-planned velocity \vec{v}₁⁺ᵣₑₚₗₐₙ=\vec{v}₁⁺ₙₒₘ−H₁₂⁻¹(τ)H₁₁(τ)Δ\vec{p} from the equations above. Thus, a new re-planned-trajectory would be as follows:

$$( \begin{matrix}{\vec{p}}_{replan} ( t ) \\ {\vec{v}}_{replan} ( t )\end{matrix} ) = ( \begin{matrix}{H}_{11} ( t ) & {H}_{12} ( t ) \\ {H}_{21} ( t ) & {H}_{22} ( t )\end{matrix} ) ( \begin{matrix}{\vec{p}}_{1 nom} + Δ \vec{p} \\ {\vec{v}}_{1 nom}^{+} - {H}_{12}^{- 1} ( τ ) {H}_{11} ( τ ) Δ \vec{p}\end{matrix} ) ,$$

and a re-planned thruster-burn would be:

\vec{b}ᵣₑₚₗₐₙ=\vec{b}ₙₒₘ−H₁₂⁻¹(τ)H₁₁(τ)Δ\vec{p}−Δ\vec{v}₁⁻. (2)

Unfortunately, a further sensor error must be accounted for in order to include all variations. Although Δ\vec{p} and Δ\vec{v}₁⁻ may be determined by using sensors onboard space-vehicle 202 and/or sensors at ground station 204, these sensors may have accuracy limitations and contribute a sensor error for position, δ\vec{p}ₑᵣᵣ, and velocity, δ\vec{v}₁⁻ₑᵣᵣ. Furthermore, the thruster-burn may not be executed perfectly, resulting in a thruster-burn error, δ\vec{b}ₑᵣᵣ. The actual velocity before a thruster-burn is: \vec{v}₁⁻_{actual}=\vec{v}₁⁻ₙₒₘ+Δ\vec{v}₁⁻+δ\vec{v}₁⁻ₑᵣᵣ. Thus, the actual departure velocity is: \vec{v}₁⁺_{actual}=\vec{v}₁⁻_{actual}+(\vec{b}ᵣₑₚₗₐₙ+δ\vec{b}ₑᵣᵣ)=\vec{v}₁⁺ₙₒₘ−H₁₂⁻¹(τ)H₁₁(τ)Δ\vec{p}+δ\vec{v}₁⁻ₑᵣᵣ+δ\vec{b}ₑᵣᵣ. A table of expressions is provided below as a summary of the discussion so far.

Table of Expressions

| Expression | Definition |
|---|---|
| \vec{p}₂ | desired destination |
| τ | desired flight time to destination |
| \vec{p}₁ | originally-planned departure point |
| \vec{p}₁ + Δ\vec{p} | best estimate of departure point |
| \vec{p}₁ + Δ\vec{p} + δ\vec{p}ₑᵣᵣ | actual departure point |
| \vec{v}₁⁻ₙₒₘ | originally-planned pre-burn velocity |
| Δ^{\vec{v}}₁⁻ₙₒₘ + Δ^{\vec{v}}₁⁻ | best estimate of pre-burn velocity |
| \vec{v}₁⁻ₙₒₘ + Δ\vec{v}₁⁻ + δ\vec{v}₁⁻ₑᵣᵣ | actual pre-burn velocity |
| \vec{b}ₙₒₘ | originally-planned burn (delta-V) |
| \vec{b}ᵣₑₚₗₐₙ = \vec{b}ₙₒₘ − H₁₂⁻¹(τ) | replanned burn |
| H₁₁(τ)Δ\vec{p} − Δ\vec{v}₁⁻ | |
| \vec{b}ₙₒₘ − H₁₂⁻¹(τ) H₁₁(τ)Δ\vec{p} − | actual burn |
| Δ\vec{v}₁⁻ + δ\vec{b}ₑᵣᵣ | |
| \vec{v}₁⁺ₙₒₘ | originally-planned departure velocity |
| \vec{v}₁⁺ₙₒₘ − H₁₂⁻¹(τ) H₁₁(τ)Δ\vec{p} | replanned departure velocity |
| \vec{v}₁⁺ₙₒₘ − H₁₂⁻¹(τ) H₁₁(τ)Δ\vec{p} + | actual departure velocity |
| δ\vec{v}₁⁻ₑᵣᵣ + δ\vec{b}ₑᵣᵣ | |

Based on the above discussion, an actual trajectory of space-vehicle 202 from \vec{p}₁ would be:

$$\begin{matrix}( \begin{matrix}{\vec{p}}_{actual} ( t ) \\ {\vec{v}}_{actual} ( t )\end{matrix} ) = ( \begin{matrix}{H}_{11} ( t ) & {H}_{12} ( t ) \\ {H}_{21} ( t ) & {H}_{22} ( t )\end{matrix} ) ( \begin{matrix}{\vec{p}}_{1 nom} + Δ \vec{p} + δ {\vec{p}}_{err} \\ \begin{matrix}{\vec{v}}_{1 nom}^{+} - {H}_{12}^{- 1} ( τ ) {H}_{11} ( τ ) Δ \vec{p} + \\ δ {\vec{v}}_{1 err}^{-} + δ {\vec{b}}_{err}\end{matrix}\end{matrix} ) \\ = ( \begin{matrix}{\vec{p}}_{nom} ( t ) \\ {\vec{v}}_{nom} ( t )\end{matrix} ) + ( \begin{matrix}{H}_{11} ( t ) & {H}_{12} ( t ) \\ {H}_{21} ( t ) & {H}_{22} ( t )\end{matrix} ) ( \begin{matrix}Δ \vec{p} + δ {\vec{p}}_{err} \\ \begin{matrix}- {H}_{12}^{- 1} ( τ ) {H}_{11} ( τ ) Δ \vec{p} + \\ δ {\vec{v}}_{1 err}^{-} + δ {\vec{b}}_{err}\end{matrix}\end{matrix} ) ,\end{matrix} \qquad ( 3 )$$

where \vec{p}ₙₒₘ(t) and \vec{v}ₙₒₘ(t) are the position and velocity of space-vehicle 202 after the thruster-burn if there were no errors. That is:

$$( \begin{matrix}{\vec{p}}_{nom} ( t ) \\ {\vec{v}}_{nom} ( t )\end{matrix} ) = ( \begin{matrix}{H}_{11} ( t ) & {H}_{12} ( t ) \\ {H}_{21} ( t ) & {H}_{22} ( t )\end{matrix} ) ( \begin{matrix}{\vec{p}}_{1 nom} \\ {\vec{v}}_{1 nom}^{+}\end{matrix} ) .$$

From equation (3) above, we can define a deviation of the actual trajectory from the pre-planned trajectory to be:

$$( \begin{matrix}δ \vec{p} ( t ) \\ δ \vec{v} ( t )\end{matrix} ) = ( \begin{matrix}{H}_{11} ( t ) & {H}_{12} ( t ) \\ {H}_{21} ( t ) & {H}_{22} ( t )\end{matrix} ) ( \begin{matrix}Δ \vec{p} + δ {\vec{p}}_{err} \\ - {H}_{12}^{- 1} ( τ ) {H}_{11} ( τ ) Δ \vec{p} + δ {\vec{v}}_{1 err}^{-} + δ {\vec{b}}_{err}\end{matrix} ) . \\ Thus , \\ \begin{matrix} δ \vec{p} ( t ) = ( {H}_{11} ( t ) {H}_{12} ( t ) ) ( \begin{matrix}Δ \vec{p} + δ {\vec{p}}_{err} \\ - {H}_{12}^{- 1} ( τ ) {H}_{11} ( τ ) Δ \vec{p} + δ {\vec{v}}_{1 err}^{-} + δ {\vec{b}}_{err}\end{matrix} ) \\ = ( {H}_{11} ( t ) {H}_{12} ( t ) ) ( \begin{matrix}{I}_{3} & {I}_{3} & 0 & 0 \\ - {H}_{12}^{- 1} ( τ ) {H}_{11} ( τ ) & 0 & {I}_{3} & {I}_{3}\end{matrix} ) ( \begin{matrix}\begin{matrix}\begin{matrix}Δ \vec{p} \\ δ {\vec{b}}_{err}\end{matrix} \\ δ {\vec{v}}_{1 err}^{-}\end{matrix} \\ δ {\vec{b}}_{err}\end{matrix} ) .\end{matrix} \qquad ( 4 )$$

where I₃ denotes a 3×3 identity matrix.

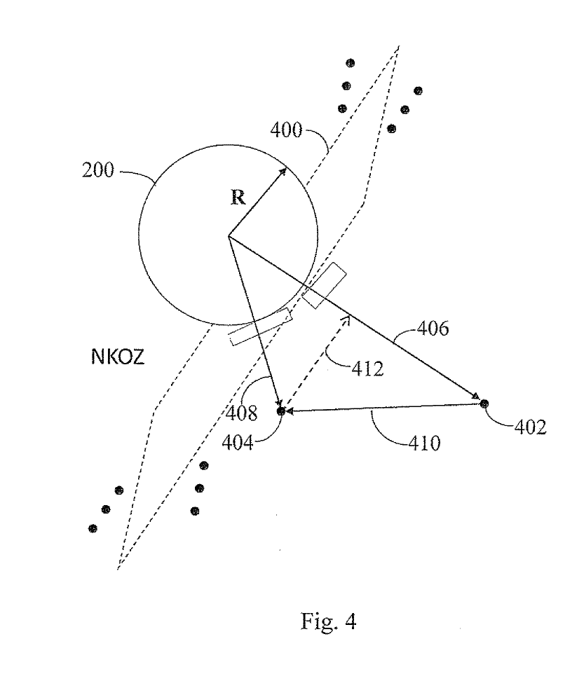

Equation (4) above provides the expression for a deviation of a trajectory which is shown in FIG. 4, where an actual position 404 deviates from a nominal position 402, which corresponds to pₙₒₘ(t) in the above discussion, by a deviation vector 410 which corresponds to δ\vec{p}(t) in the above discussion. The nominal position 402 is represented by a vector 406 and the actual position is represented by a vector 408. If KOZ 200 boundary condition is enforced, then it is necessary to ensure that vector 408 does not have a magnitude that is less than radius R of KOZ 200 for any values of the error variables within appropriate bounds. In view of equation (4) above, it is a very difficult problem to determine values of δp(t) when passive-safety is lost.

However, a closed form solution can be found if instead of KOZ 200, a new time dependent KOZ (NKOZ(t)) is defined as a half-space that is bounded by a plane 400 tangential to KOZ 200 at a point where vector 406 intersects KOZ 200 for each position pₙₒₘ(t) of space-vehicle 202. NKOZ(t) makes it possible to determine, for a particular position pₙₒₘ(t) of the space-vehicle 202, whether a thruster-burn would send space-vehicle 202 into a possible trajectory that violates passive-safety requirements by penetrating the NKOZ(t). NKOZ(t) is a conservative boundary condition because for a spherical KOZ 200, KOZ 200 is in the NKOZ(t) half-space for every position pₙₒₘ(t) of space-vehicle 202.

To enforce the NKOZ(t), a magnitude of vector 408 (or \vec{p}_{actual}(t)) projected onto a unit vector in a direction of vector 406 (or \hat{p}(t)) must be greater than or equal to R. This condition can be expressed as:

\vec{p}_{actual}(t)·\hat{p}ₙₒₘ(t)≧R (5)

where ∩ is an inner or dot product and \hat{p}ₙₒₘ(t) is a unit vector of \vec{p}ₙₒₘ(t). Thus, \hat{p}ₙₒₘ(t)=\vec{p}ₙₒₘ(t)/∥\vec{p}ₙₒₘ(t)∥, and ∥\vec{p}ₙₒₘ(t)∥ is the magnitude of \vec{p}ₙₒₘ(t). Expanding equation (5) and applying equations (3) and (4) result in:

$$( {\vec{p}}_{nom} + δ \vec{p} ( t ) ) \cdot {\hat{p}}_{nom} ( t ) \geq R \\ ‖ {\vec{p}}_{nom} ( t ) ‖ + δ \vec{p} ( t ) \cdot {\hat{p}}_{nom} ( t ) \geq R \\ {( {\hat{p}}_{nom} ( t ) )}^{T} δ \vec{p} ( t ) ) \geq R - ‖ {\vec{p}}_{nom} ( t ) ‖ \\ {( {\hat{p}}_{nom} ( t ) )}^{T} ( {H}_{11} ( t ) {H}_{12} ( t ) ) ( \begin{matrix}{I}_{3} & {I}_{3} & 0 & 0 \\ - {H}_{12}^{- 1} ( τ ) {H}_{11} ( τ ) & 0 & {I}_{3} & {I}_{3}\end{matrix} ) ( \begin{matrix}\begin{matrix}\begin{matrix}Δ \vec{p} \\ δ {\vec{p}}_{err}\end{matrix} \\ δ {\vec{v}}_{1 err}^{-}\end{matrix} \\ δ {\vec{b}}_{err}\end{matrix} ) \geq R - ‖ {\vec{p}}_{nom} ( t ) ‖ \\ - {( {\hat{p}}_{nom} ( t ) )}^{T} ( {H}_{11} ( t ) {H}_{12} ( t ) ) ( \begin{matrix}{I}_{3} & {I}_{3} & 0 & 0 \\ - {H}_{12}^{- 1} ( τ ) {H}_{11} ( τ ) & 0 & {I}_{3} & {I}_{3}\end{matrix} ) ( \begin{matrix}\begin{matrix}\begin{matrix}Δ \vec{p} \\ δ {\vec{p}}_{err}\end{matrix} \\ δ {\vec{v}}_{1 err}^{-}\end{matrix} \\ δ {\vec{b}}_{err}\end{matrix} ) \leq ‖ {\vec{p}}_{nom} ( t ) ‖ - R . \qquad ( 6 )$$

For simplification purposes, 3×1 vectors \vec{c}₁(t), \vec{c}₂(t), \vec{c}₃(t), and \vec{c}₄(t) are defined by:

$$[ \begin{matrix}{\vec{c}}_{1}^{T} ( t ) & {\vec{c}}_{2}^{T} ( t ) & {\vec{c}}_{3}^{T} ( t ) & {\vec{c}}_{4}^{T} ( t )\end{matrix} ] = - {( {\hat{p}}_{nom} ( t ) )}^{T} ( {H}_{11} ( t ) {H}_{12} ( t ) ) ( \begin{matrix}{I}_{3} & {I}_{3} & 0 & 0 \\ - {H}_{12}^{- 1} ( τ ) {H}_{11} ( τ ) & 0 & {I}_{3} & {I}_{3}\end{matrix} ) .$$

### Thus:

\vec{c}₁^{T}(t)=−(\hat{p}ₙₒₘ(t))^{T}[H₁₁(t)−H₁₂(t)H₁₂⁻¹(τ)H₁₁(τ)];

\vec{c}₂^{T}=−(\vec{p}ₙₒₘ(t))^{T}H₁₁(t);

\vec{c}₃^{T}=−(\vec{p}ₙₒₘ(t))^{T}H₁₂(t); and

\vec{c}₄^{T}=−(\vec{p}ₙₒₘ(t))^{T}H₁₂(t).

Equation (6) can now be written as:

$$[ \begin{matrix}{\vec{c}}_{1}^{T} ( t ) & {\vec{c}}_{2}^{T} ( t ) & {\vec{c}}_{3}^{T} ( t ) & {\vec{c}}_{4}^{T} ( t )\end{matrix} ] ( \begin{matrix}\begin{matrix}\begin{matrix}Δ \vec{p} \\ δ {\vec{p}}_{err}\end{matrix} \\ δ {\vec{v}}_{1 err}^{-}\end{matrix} \\ δ {\vec{b}}_{err}\end{matrix} ) \leq ‖ {\vec{p}}_{nom} ( t ) ‖ - R , or {\vec{c}}_{1}^{T} ( t ) Δ \vec{p} + {\vec{c}}_{2}^{T} ( t ) δ {\vec{p}}_{err +} {\vec{c}}_{3}^{T} ( t ) δ {\vec{v}}_{1 err}^{-} + {\vec{c}}_{4}^{T} ( t ) δ {\vec{b}}_{err} \leq ‖ {\vec{p}}_{nom} ( t ) ‖ - R . \qquad ( 7 )$$

Equation (7) can be further improved by bounding δ\vec{p}ₑᵣᵣ, δ\vec{v}₁⁻ₑᵣᵣ, and δ\vec{b}ₑᵣᵣ to obtain a solution that can be implemented by a rendezvous apparatus. The magnitude of the position and velocity sensor error can be bounded to be less than or equal to δpₘₐₓ and δvₘₐₓ. Thus, ∥δ\vec{p}ₑᵣᵣ∥≦δpₘₐₓ and ∥δ\vec{v}₁⁻ₑᵣᵣ∥≦δvₘₐₓ. This leads to: |\vec{c}₂^{T}(t)δ\vec{p}ₑᵣᵣ|≦∥\vec{c}₂(t)∥δpₘₐₓ and |\vec{c}₃^{T}(t)δ\vec{v}₁⁻ₑᵣᵣ|≦∥\vec{c}₃(t)∥δvₘₐₓ. Thus, equation (7) above can be written as: \vec{c}₁^{T}(t)Δ\vec{p}+∥\vec{c}₂(t)∥δpₘₐₓ+∥\vec{c}₃(t)∥δvₘₐₓ+\vec{c}₄^{T}(t)δ\vec{b}ₑᵣᵣ≦∥\vec{p}ₙₒₘ(t)∥−R. Rearranging, this equation becomes:

\vec{c}₁^{T}(t)Δ\vec{p}+\vec{c}₄^{T}(t)δ\vec{b}ₑᵣᵣ≦∥\vec{p}ₙₒₘ(t)∥−R−∥\vec{c}₂(t)∥δpₘₐₓ−∥\vec{c}₃(t)∥δvₘₐₓ. (8)

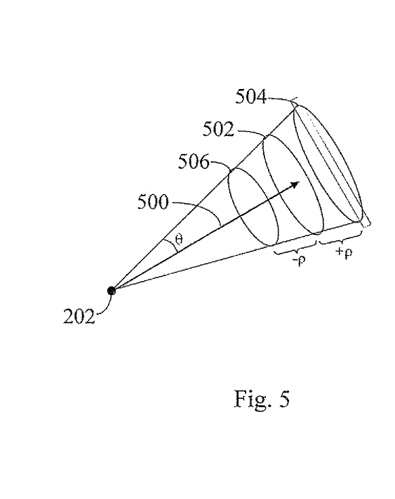

FIG. 5 shows an example of thruster-burn error, δ\vec{b}ₑᵣᵣ. Vector 500 represents a re-planned thruster-burn \vec{b}ᵣₑₚₗₐₙ having a re-planned magnitude represented by a center of disk 502. Possible errors in executing the planned thruster-burn may be represented as a cone having a cone angle of θ, and disks 504 and 506 distanced from disk 502 by ±ρ. For large values of θ, disks 502-506 would be sections of spheres. But, for small values of θ, such as those representing thruster-burn directional errors, disks 502-506 may be reasonably illustrated as disks. An angle error component of the thruster-burn may be represented by \vec{θ} with elements θ₁, θ₂, and θ₃ for roll, pitch and yaw, and a magnitude error component may be represented by ρ. An actual thruster-burn may be expressed as:

\vec{b}_{actual}=(1+ρ)R_{θ}\vec{b}ᵣₑₚₗₐₙ,

where R_{θ} is a rotational matrix based on \vec{θ} that is well known in the art. See, e.g., John J. Craig, Introduction to Robotics; Mechanics and Control, Chapter 2 and Appendix B, Second Edition, Addison-Wesley, Reading, Mass., 1989; and Wikipedia at: http://en.wikipedia.org/wiki/Rotation_matrix#General_rotations. To a first order approximation, R_{θ} may be expressed as:

$${R}_{θ} = ( \begin{matrix}1 & - {θ}_{3} & {θ}_{2} \\ {θ}_{3} & 1 & - {θ}_{1} \\ - {θ}_{2} & {θ}_{1} & 1\end{matrix} ) .$$

Based on the above, thruster-burn error may be expressed as:

$$\begin{matrix}δ {\vec{b}}_{err} = {\vec{b}}_{actual} - {\vec{b}}_{replan} \\ = ( 1 + ρ ) {R}_{θ} {\vec{b}}_{replan} - {\vec{b}}_{replan} \\ = ( \begin{matrix}1 + ρ & - ( 1 + ρ ) {θ}_{3} & ( 1 + ρ ) {θ}_{2} \\ ( 1 + ρ ) {θ}_{3} & 1 + ρ & - ( 1 + ρ ) {θ}_{1} \\ - ( 1 + ρ ) {θ}_{2} & ( 1 + ρ ) {θ}_{1} & 1 + ρ\end{matrix} ) {\vec{b}}_{replan} - {\vec{b}}_{replan} .\end{matrix}$$

In reality, ρθᵢ<<1, for i=1, 2, and 3. Thus, neglecting second order terms,

$$\begin{matrix}δ {\vec{b}}_{err} = ( \begin{matrix}1 + ρ & - {θ}_{3} & {θ}_{2} \\ {θ}_{3} & 1 + ρ & - {θ}_{1} \\ - {θ}_{2} & {θ}_{1} & 1 + ρ\end{matrix} ) {\vec{b}}_{replan} - {\vec{b}}_{replan} \\ = ( \begin{matrix}ρ & - {θ}_{3} & {θ}_{2} \\ {θ}_{3} & ρ & - {θ}_{1} \\ - {θ}_{2} & {θ}_{1} & ρ\end{matrix} ) {\vec{b}}_{replan} .\end{matrix}$$

If the 3×3 matrix is represented by S(ρ, \vec{θ}), then the above equation becomes: δ\vec{b}ₑᵣᵣ=S(ρ, \vec{θ})\vec{b}ᵣₑₚₗₐₙ. Applying equation (2), the thruster-burn error becomes:

δ\vec{b}ₑᵣᵣ=S(ρ,\vec{θ})(\vec{b}ₙₒₘ−H₁₂⁻¹(τ)H₁₁(τ)Δ\vec{p}−Δ\vec{v}₁⁻). (9)

Combining equations (8) and (9) results in:

\vec{c}₁^{T}Δ\vec{p}+\vec{c}₄^{T}(t)[S(ρ,\vec{θ})(\vec{b}ₙₒₘ−H₁₂⁻¹(τ)H₁₁(τ)Δ\vec{p}−Δ\vec{v}₁⁻)]≦∥\vec{p}ₙₒₘ(t)∥−R−∥\vec{c}₂(t)∥δpₘₐₓ−∥\vec{c}₃(t)∥δvₘₐₓ. (10)

If equation (10) is satisfied for all |ρ|≦ρₘₐₓ, and ∥\vec{θ}∥≦θₘₐₓ, then passive-safety is guaranteed. This guarantee is achieved if equation (10) is satisfied for ρ=±ρₘₐₓ and \vec{θ}=[±θₘₐₓ, ±θₘₐₓ, ±θₘₐₓ], where each of the plus-or-minus degrees of freedom is independent of other degrees of freedom. A proof of the above assertion is provided in section 6 of Provisional Application No. 61/563,259 filed on Nov. 11, 2011, which is hereby incorporated by reference in its entirety. Thus, equation (10) may be expanded into 16 equations for all possibilities of ρ=±ρₘₐₓ, θ₁=±θₘₐₓ, θ₂=±ₘₐₓ, and θ₃=±θₘₐₓ. Constraining each individually is more conservative than constraining ∥\vec{θ}∥≦θₘₐₓ because more vectors \vec{θ} satisfy |θⱼ|≦θₘₐₓ for j=1, 2, and 3 than satisfy ∥\vec{θ}∥≦θₘₐₓ.

All 16 equations may be written as: \vec{c}₁^{T}(t)Δ\vec{p}+\vec{c}₄^{T}(t)[S(±ρₘₐₓ,±\vec{θ}ₘₐₓ)(\vec{b}ₙₒₘ−H₁₂⁻¹(τ)H₁₁(τ)Δ\vec{p}−Δ\vec{v}₁^{-)]≦∥\vec{p}}ₙₒₘ(t)∥−R−∥\vec{c}₂(t)∥δpₘₐₓ−∥\vec{c}₃(t)∥δvₘₐₓ, where it is understood that the notation “±\vec{θ}ₘₐₓ” implies plus-or-minus on scalar components of \vec{θ} independently from one another, and independently from the plus-or-minus on pₘₐₓ. The above equation can be rewritten as:

[\vec{c}^{T}(t)−\vec{c}₄^{T}(t)S(±ρₘₐₓ,±\vec{θ}ₘₐₓ)H₁₂⁻¹(τ)H₁₁(τ)]Δ\vec{p}+[−\vec{c}₄^{T}(t)S(±ρₘₐₓ,±\vec{θ}ₘₐₓ)]Δ\vec{v}₁⁻≦∥\vec{p}ₙₒₘ(t)∥−R−∥\vec{c}₂(t)∥δpₘₐₓ−∥\vec{c}(t)∥δvₘₐₓ−\vec{c}₄^{T}(t)S(±ρₘₐₓ,±\vec{θ}ₘₐₓ)\vec{b}ₙₒₘ. (11)

To eliminate equation (11)'s dependence on Δ\vec{v}₁⁻, an assumption that ∥Δ\vec{v}₁⁻∥Δvₘₐₓ is made. This means that a pre-thruster-burn velocity error (i.e., the deviation of velocity from a nominal velocity) must be within Δvₘₐₓ. Based on this assumption, equation (11) can be written as:

[ĉ₁^{T}(t)−ĉ₄^{T}(t)S(±ρₘₐₓ,±\hat{θ}ₘₐₓ)H₁₂⁻¹(τ)H₁₁(τ)]Δ\vec{p}+∥\vec{c}₄^{T}(t)S(±ρₘₐₓ,±\vec{θ}ₘₐₓ)∥Δvₘₐₓ≦∥\vec{p}ₙₒₘ(t)∥−R−∥\vec{c}₂(t)∥δpₘₐₓ−∥\vec{c}₃(t)∥δvₘₐₓ−\vec{c}^{T}(t)S(±ρₘₐₓ,±\vec{θ}ₘₐₓ)\vec{b}ₙₒₘ. (12)

Thus, if equation (12) is satisfied, then equation (11) is also satisfied. Equation (12) can be rearranged as:

[\vec{c}₁^{T}(t)−\vec{c}₄^{T}(t)S(±ρₘₐₓ,±\vec{θ}ₘₐₓ)H₁₂⁻¹(τ)H₁₁(τ)]Δ\vec{p}≦∥\vec{p}ₙₒₘ(t)∥−R−∥\vec{c}₂(t)∥δpₘₐₓ−∥ĉ₃(t)∥δvₘₐₓ−ĉ₄^{T}(t)S(±ρₘₐₓ,±\vec{θ}ₘₐₓ)\vec{b}ₙₒₘ−∥\vec{c}₄^{T}(t)S(±ρₘₐₓ,±\hat{θ}ₘₐₓ. (13)

In equation (13), all the terms to the right of the inequality are known quantities for a specific time tᵢ. Thus, equation (13) provides computable limits on Δ\vec{p} for any specific time tᵢ to achieve passive-safety.

As a practical matter, the right side of equation (13) cannot be zero to avoid division by zero that may occur in future calculations. The right side of the equation becomes zero if a trajectory touches a surface of KOZ 200 without penetrating it. If this condition is detected, the user is notified that passive-safety cannot be guaranteed.

For convenience, new variables are introduced to simplify equation (13) as follows:

\vec{c}ₚ^{T}(t)=\vec{c}₁(t)−\vec{c}₄^{T}(t)S(±ρₘₐₓ,±\vec{θ}ₘₐₓ)H₁₂⁻¹(τ)H₁₁(τ); and

β(t)=∥\vec{p}ₙₒₘ(t)∥−R−∥\vec{c}₂(t)∥δpₘₐₓ−∥\vec{c}₃(t)∥δvₘₐₓ−ĉ₄^{T}(t)S(±ρₘₐₓ,±\vec{θ}ₘₐₓ)\vec{b}ₙₒₘ−∥\vec{c}₄^{T}(t)S(±ρₘₐₓ,±\vec{θ}ₘₐₓ)∥Δvₘₐₓ. (14)

Thus, equation (13) can now be written as:

\vec{c}ₚ^{T}(t)Δ\vec{p}≦β(t). (15)

As noted earlier, there is one NKOZ(tᵢ) for each nominal position pᵢ of space-vehicle 202 that is propagated from p₁, for example. Thus, passive-safety can be ensured only for positions after a thruster-burn for which a position pᵢ is calculated. For example, if it is determined that passive-safety is to be ensured for 48 hours after each thruster-burn, and pᵢ is calculated for each minute after the thruster-burn, then equation (15) must be processed for 48×60=2880 times. Thus, runs from 1 to 2880 which means 2880 half-space NKOZs are applied as boundary conditions.

As noted above, for each NKOZ(tᵢ) half-space, equation (15) includes 16 conditions (ρ=±ρₘₐₓ, θ₁=±θₘₐₓ, θ₂=±θₘₐₓ, and θ₃=±θₘₐₓ). Thus, equation (15) must be processed once for each of these 16 conditions. For 2880 NKOZ(tᵢ) half-spaces, equation (15) must be processed 46,080 times.

In view of the above, equation (15) may be expressed as a system of inequalities as follows:

$$( \begin{matrix}{\vec{c}}_{p 1}^{T} \\ {\vec{c}}_{p 2}^{T} \\ ⋮ \\ {\vec{c}}_{p n}^{T}\end{matrix} ) Δ \vec{p} \leq ( \begin{matrix}{β}_{1} \\ {β}_{2} \\ ⋮ \\ {β}_{n} ,\end{matrix} )$$

where n=46,080 for 48 hours of passive-safety.

$$If {C}_{P} = ( \begin{matrix}{\vec{c}}_{p 1}^{T} \\ {\vec{c}}_{p 2}^{T} \\ ⋮ \\ {\vec{c}}_{p n}^{T}\end{matrix} ) and \vec{β} = ( \begin{matrix}{β}_{1} \\ {β}_{2} \\ ⋮ \\ {β}_{n}\end{matrix} ) ,$$

then the above equation can be written as:

C_{P}Δ\vec{p}≦\vec{β}. (16)

Each of C_{P} and \vec{β} has 46,080 rows. This large number of inequalities (thus required processing power) may be reduced by identifying non-redundant inequalities of equation (16).

Each of the 46,080 inequalities defines a half-space boundary on Δ\vec{p}. Thus, equation (15) defines an intersection of 46,080 half-spaces where each half-space is defined by one inequality. Solving this large system of inequalities can therefore be transformed into solving for the intersection of half-spaces which is a well-studied problem in computational geometry. A preferred way to solve for the intersection of half-spaces is by mapping each inequality of equation (16) from real-space into a point in a dual-space and identifying points on a convex hull of all such points. See, e.g., Franco P. Preparata and Michael Ian Shamos, Computational Geometry: An Introduction, Springer-Verlag, pages 104-124, 141-146, and 315-320, New York, 1985.

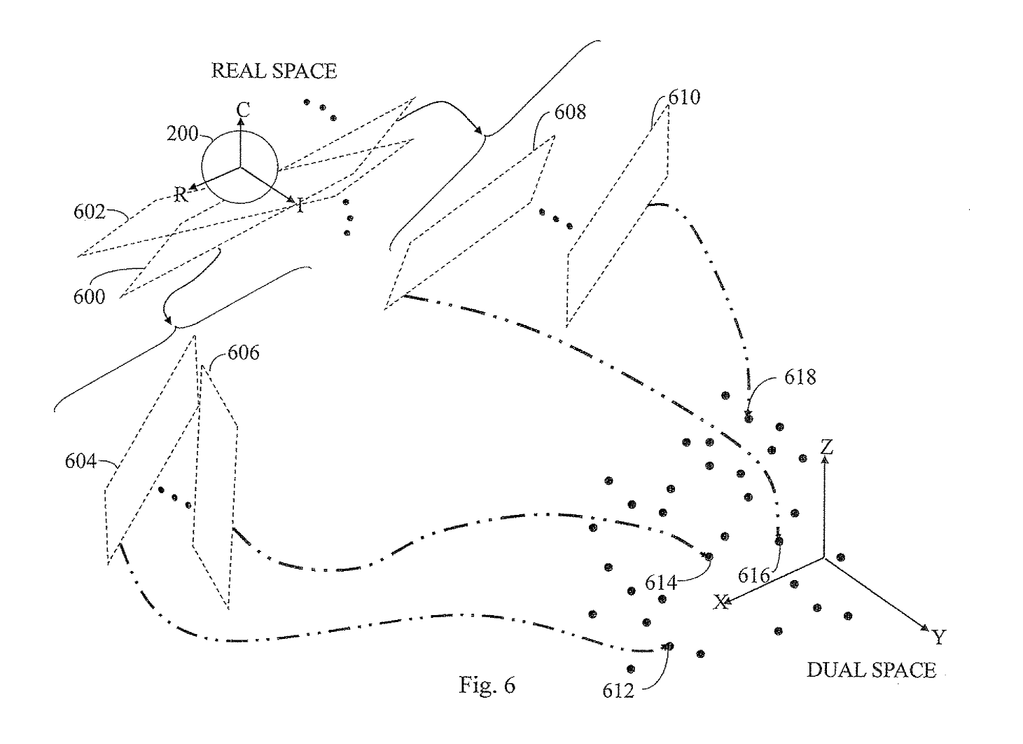

FIG. 6 shows exemplary NKOZ half-spaces represented as planes 600 and 602. As discussed above, there are 2880 NKOZ half-spaces for 48 hours in one minute increments. Each NKOZ results in 16 inequalities that define 16 half-spaces that are boundaries for a set of passively-safe thruster-burn positions p′₁ with reference to FIG. 3, for example. As shown in FIG. 6, NKOZ half-space 600 corresponds to 16 half-spaces that are represented by planes 604-606, and NKOZ half-space 602 corresponds to 16 half-spaces represented by planes 608-610. Thirty two half-spaces are mapped into dual-space as thirty two points represented by points 612-618; each half-space in real-space maps into a point in dual-space.

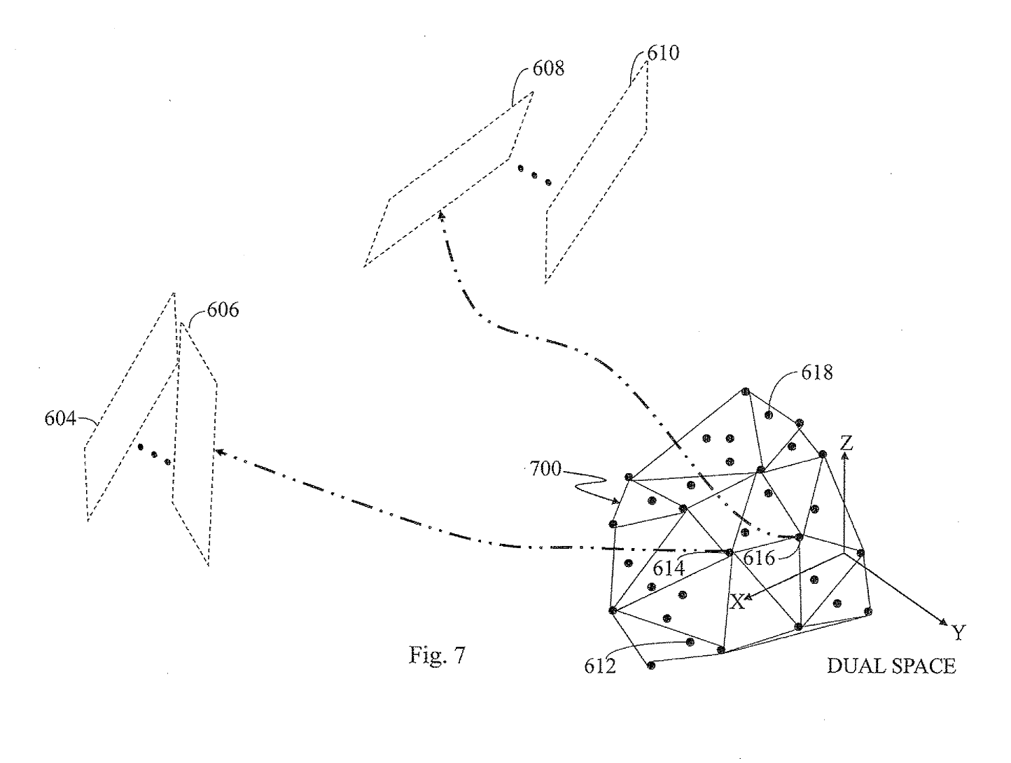

Once all the 46,080 half-spaces in real-space are mapped into dual-space, a convex hull process may be performed to identify those points in dual-space that are on the convex hull. The convex hull is a smallest polyhedron that contains all the points in dual-space. FIG. 7 shows an example convex hull 700 that is formed by connecting points 614 and 616 among other points that are on a perimeter surface. As an example, points 612 and 618 are not on the perimeter surface and thus are not on convex hull 700. The points on convex hull 700 identify non-redundant half-spaces in real-space that are boundaries for a set of passively-safe thruster-burn positions p′₁. Preparata and Shamos referenced above provide a method for forming the convex hull. Other algorithms may also be used such as the gift-wrap algorithm.

In the gift-wrap algorithm, first form a plane parallel to the XY plane that passes through a point with a lowest Z coordinate. Rotate this plane until another point is found. Rotate the plane about a line (an edge) between the two points until a third point is found. A triangle formed by the above three points forms a first face of the convex hull. Continue rotating the plan about one of the edges of the triangle to find another face, and so one until all faces are found.

Section 7 of the incorporated Provisional Application No. 61/563,259, demonstrates that half-space constraints corresponding to points internal to a convex hull are satisfied if constraints of points on the convex hull are satisfied. This fact means that the constraints of internal points in dual-space are redundant to the constraints of the points on the convex hull. Thus, only constraints of points on the convex hull need to be identified and mapped back into real-space to form a polyhedron or basket of estimated positions from which a passively-safe thruster-burn may be executed.

The convex hull may be reduced in complexity by introducing artificial constraints on Δ\vec{p} to bound its size to a largest Δ\vec{p} that may reasonably be expected to occur. The artificial points form a convex hull surface portion that makes interior those potentially large number of points that would have formed a corresponding convex hull portion. For example, if 500 meters is determined to be greater than any expected ∥Δ\vec{p}∥ that can occur in real-life experience, then the following inequalities can be appended to equation (16):

$$( \begin{matrix}1 & 0 & 0 \\ - 1 & 0 & 0 \\ 0 & 1 & 0 \\ 0 & - 1 & 0 \\ 0 & 0 & 1 \\ 0 & 0 & - 1\end{matrix} ) Δ \vec{p} \leq ( \begin{matrix}500 \\ 500 \\ 500 \\ 500 \\ 500 \\ 500\end{matrix} ) .$$

One or more of these point is likely to appear on the convex hull, thus, eliminating a plurality of other points from the convex hull.

After points on the convex hull are identified, these identified points may be mapped back into real-space as half-spaces which when merged together form a polyhedron (the basket) that encloses those position values from which a thruster-burn can be safely executed. Going back to FIG. 7, points 614 and 616 (among other points on convex hull 700) may be mapped back into real-space half-spaces represented by planes 606 and 608 which are boundary conditions on a basket of passively-safe positions. Edges of convex hull 700 map to the edges of the basket. Faces of convex hull 700 map to vertices of the basket. See, e.g., Preparata and Shamos pages 24-26 and 307-308. As noted in the Provisional Application No. 61/563,259, the above discussed three dimensional polyhedron may be reduced to a two dimensional polygon by eliminating one of the coordinates such as the C coordinate so that space-vehicle 202 may maneuver only in a plane of the orbit 104, for example. This simplification also makes the thruster-burn angle error θ a scalar, which reduces the number of constraints from 16 for each time sample to 4 per time sample.

In the above discussion, it is assumed that each thruster-burn is adjusted to compensate for position errors seen so far by aiming space-vehicle 202 at a next nominal position. However, only slight modifications to equations (3), (4), (7), (8) and (13) are needed if each thruster-burn is executed as originally planned. The following provides equation differences if no adjustment is made in the thruster-burn.

Equations (3), (4), (7), (8), (13), and (14) are modified to equations (3A), (4A), (7A), (8A), (13A), and (14A) as follows:

$$\begin{matrix}( \begin{matrix}{\vec{p}}_{nom} ( t ) \\ {\vec{v}}_{nom} ( t )\end{matrix} ) = ( \begin{matrix}{\vec{p}}_{nom} ( t ) \\ {\vec{v}}_{nom} ( t )\end{matrix} ) + ( \begin{matrix}{H}_{11} ( t ) & {H}_{12} ( t ) \\ {H}_{21} ( t ) & {H}_{22} ( t )\end{matrix} ) ( \begin{matrix}Δ \vec{p} + δ {\vec{p}}_{err} \\ Δ {\vec{v}}_{1}^{-} + δ {\vec{v}}_{1 err}^{-} + δ {\vec{b}}_{err}\end{matrix} ) ; & ( 3 A ) \\ δ \vec{p} ( t ) = ( {H}_{11} ( t ) {H}_{12} ( t ) ) ( \begin{matrix}{I}_{3} & 0 & {I}_{3} & 0 & 0 \\ 0 & {I}_{3} & 0 & {I}_{3} & {I}_{3}\end{matrix} ) ( \begin{matrix}\begin{matrix}\begin{matrix}Δ \vec{p} \\ Δ {\vec{v}}_{1}^{-} \\ δ {\vec{p}}_{err}\end{matrix} \\ δ {\vec{v}}_{1 err}^{-}\end{matrix} \\ δ {\vec{b}}_{err}\end{matrix} ) ; & ( 4 A ) \\ {\vec{c}}_{1}^{T} ( t ) Δ \vec{p} + {\vec{c}}_{3}^{T} ( t ) Δ {\vec{v}}_{1}^{-} + {\vec{c}}_{2}^{T} ( t ) δ {\vec{p}}_{err} + {\vec{c}}_{3}^{T} ( t ) δ {\vec{v}}_{1 err}^{-} + {\vec{c}}_{4}^{T} ( t ) δ {\vec{b}}_{err} \leq ‖ {\vec{p}}_{nom} ( t ) ‖ - R , \\ ( Here , {\vec{c}}_{1}^{T} ( t ) = - {( {\hat{p}}_{nom} ( t ) )}^{T} [ {H}_{11} ( t ) ] ) ; & ( 7 A ) \\ {\vec{c}}_{1}^{T} ( t ) Δ \vec{p} + {\vec{c}}_{3}^{T} ( t ) Δ {\vec{v}}_{1}^{-} + {\vec{c}}_{4}^{T} ( t ) δ {\vec{b}}_{err} \leq ‖ {\vec{p}}_{nom} ( t ) ‖ - R - ‖ {\vec{c}}_{2} ( t ) ‖ δ {p}_{max} - ‖ {\vec{c}}_{3} ( t ) ‖ δ {v}_{max} ; & ( 8 A ) \\ [ {\vec{c}}_{1}^{T} ( t ) - {\vec{c}}_{4}^{T} ( t ) S ( \pm {ρ}_{max} , \pm {\vec{θ}}_{max} ) {H}_{12}^{- 1} ( τ ) {H}_{11} ( τ ) ] Δ \vec{p} \leq ‖ {\vec{p}}_{nom} ( t ) ‖ - R - ‖ {\vec{c}}_{2} ( t ) ‖ δ {p}_{max} - ‖ {\vec{c}}_{3} ( t ) ‖ ( δ {v}_{max} + Δ {v}_{max} ) - {\vec{c}}_{4}^{T} ( t ) S ( \pm {ρ}_{max} , \pm {\vec{θ}}_{max} ) {\vec{b}}_{nom} - ‖ {\vec{c}}_{4}^{T} ( t ) S ( \pm {ρ}_{max} , \pm {\vec{θ}}_{max} ) ‖ Δ {v}_{max} ; \\ and & ( 13 A ) \\ β ( t ) = ‖ {\vec{p}}_{nom} ( t ) ‖ - R - ‖ {\vec{c}}_{2} ( t ) ‖ δ {p}_{max} - ‖ {\vec{c}}_{3} ( t ) ‖ ( δ {v}_{max} + Δ {v}_{max} ) - {\vec{c}}_{4}^{T} ( t ) S ( \pm {ρ}_{max} , \pm {\vec{θ}}_{max} ) {\vec{b}}_{nom} - ‖ {\vec{c}}_{4}^{T} ( t ) S ( \pm {ρ}_{max} , \pm {\vec{θ}}_{max} ) ‖ Δ {v}_{max} . & ( 14 A )\end{matrix}$$

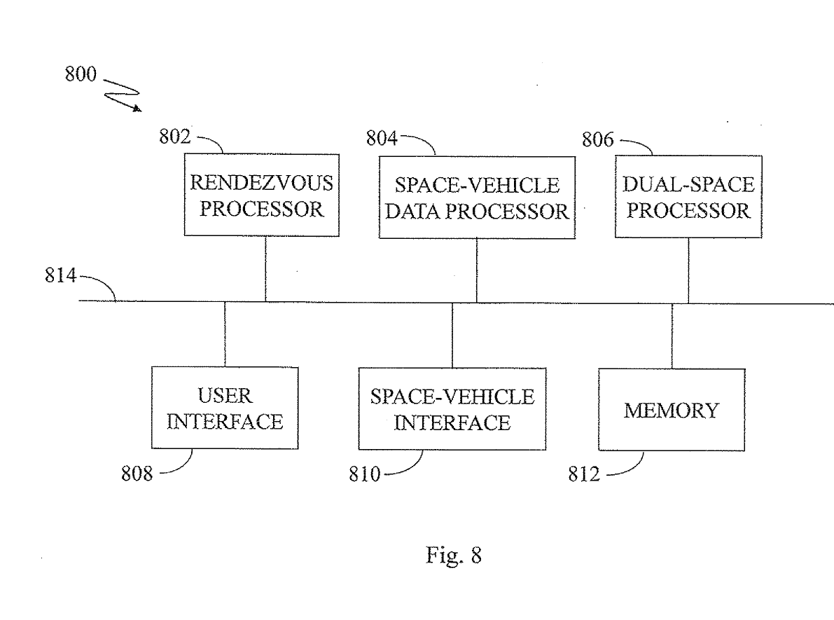

FIG. 8 shows a block diagram of an exemplary rendezvous controller 800 that includes a rendezvous processor 802, a space-vehicle data processor 804, a dual-space processor 806, a user interface 808, a space-vehicle interface 810 and a memory 812. All of the above components may be coupled together by a bus 814. Although a bus-architecture is shown as an example, other component interconnections may be used as is well known. For example, a parallel connection between components may be used where high bandwidth may be required or where tight timing requirements are present. However, for low bandwidth and/or loose timing situations, serial connections may be used. Rendezvous processor 802, space-vehicle data processor 804, and/or dual-space processor 812 may be implemented using various technologies such as PLAs, PALs, applications specific integrated circuits (ASICs), off the shelf processors, and/or software executed in one or more general purpose or special purpose processors using one or more CPUs, for example. Memory 806 may be implemented using hard disk, optical disk, and/or RAM/ROM in either volatile or nonvolatile technologies. User interface 808 may be a keyboard, a mouse or other devices for interfacing with a person such as voice recognition devices, etc., and space-vehicle interface 810 may include transmitters and receivers using various communication bands and/or optical bands. Although FIG. 8 shows rendezvous controller 800 to include user interface 808 and space-vehicle interface 810 suitable for installation at ground-station 204, these interfaces 808 and 810 may not be needed if rendezvous controller 800 is disposed in a space-vehicle such as space-vehicle 202, for example.

When a signal is received from user interface 808 indicating that a space-vehicle is ready to perform rendezvous with a resident-space-object, rendezvous processor 802 determines a next scheduled thruster-burn based on planned rendezvous data and directs space-vehicle data processor 804 to obtain from memory 812 a nominal position of space-vehicle 202 at a time of the next scheduled burn. After the nominal position of space-vehicle 202 at the time of the next scheduled thruster-burn is obtained, space-vehicle data processor 804 propagates the position of space-vehicle 202 for time samples up to maximum elapsed time T beyond the time of the next scheduled thruster-burn, and then calculates all the inequalities for each of the time samples. For example, T may be 48 hours divided into 2880 one minute intervals, and space-vehicle data processor 804 calculates all the inequalities for all 2880 positions. Space-vehicle data processor 804 retrieves maximum error limits from memory 812 such as δpₘₐₓ, δvₘₐₓ, Δvₘₐₓ, ρₘₐₓ, and θₘₐₓ, for example, and generates values for the inequalities which may be stored in memory 812. Thus, 46,080 inequalities may be calculated.

After space-vehicle data processor 804 completes generating the inequalities, dual-space processor 806 maps the inequalities into dual-space, maps into dual-space artificial constraints based on data for a maximum ∥Δ\vec{p}∥ retrieved from memory 812, forms a convex hull for all mapped points, and identifies points on the convex hull. Dual-space processor 806 maps the identified points back into real-space to form a basket of thruster-burn positions (burn locations) that will result in passive-safety after the next thruster-burn and places the real-space inequality values (basket inequalities) corresponding to the identified points into memory 812.

After the identified points on the convex hull are mapped into real-space inequality values, rendezvous processor 802 communicates with the space-vehicle through space-vehicle interface 810 to obtain sensor data to determine a detected position and velocity of the space-vehicle. After receipt of the sensor data, the detected position of the space-vehicle is propagated to a position of the next scheduled thruster-burn. Then, rendezvous processor 802 determines if all the basket inequalities are satisfied by the propagated position of the space-vehicle. If all the basket inequalities are satisfied, then rendezvous processor 802 determines whether the scheduled thruster-burn time has arrived. If the scheduled thruster-burn time has not yet arrived, then rendezvous processor 802 may continue to monitor the space-vehicle sensor data until the scheduled thruster-burn time has arrived. If all the basket inequalities are still satisfied, the scheduled thruster-burn is executed. If at any time prior to the scheduled thruster-burn time any of the basket inequalities are not satisfied, then a warning signal is output to the user. If any basket inequality is not satisfied when the time for the next scheduled thruster-burn arrives, a burn-reject signal is transmitted to the space-vehicle and/or output to a user through user interface 808 such as an alarm, for example, to alert the user of the situation.

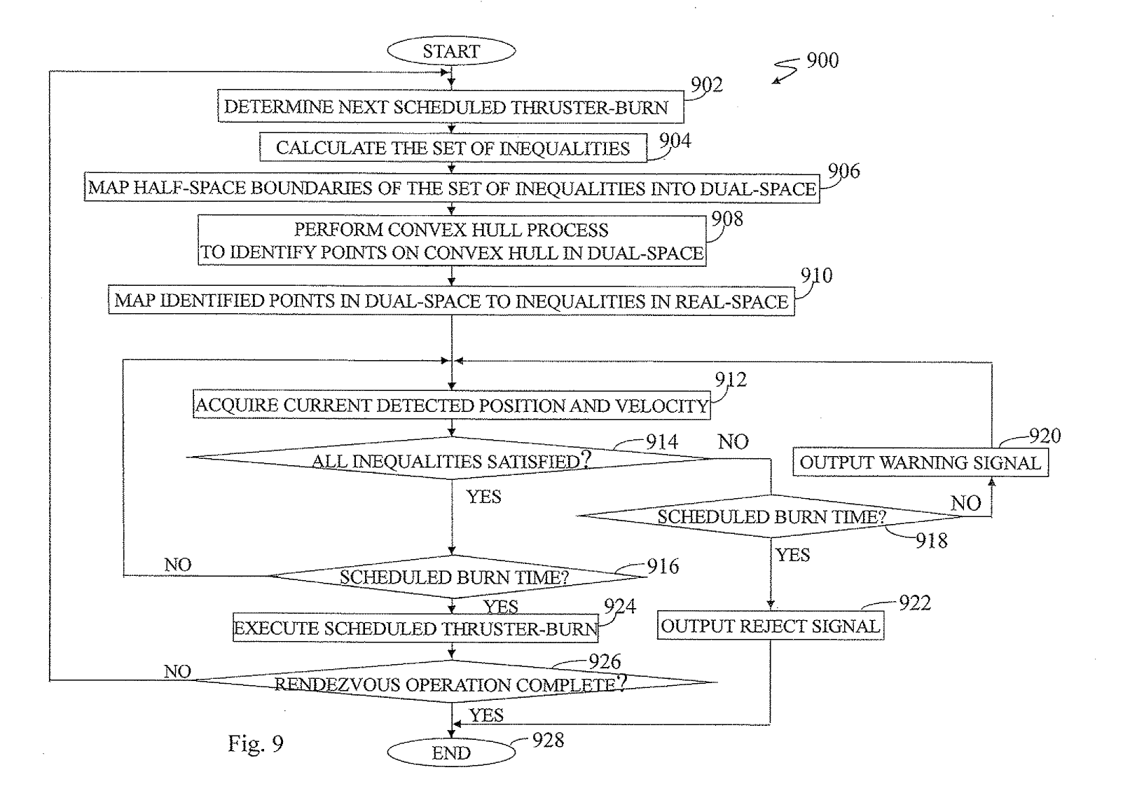

FIG. 9 shows a flow chart 900 of an exemplary process for determining whether a next scheduled thruster-burn of a space-vehicle results in passive-safety relative to a resident-space-object. In step 902, the process determines a time of the next scheduled thruster-burn, its nominal position, and its nominal pre-burn velocity, and goes to step 904. In step 904, the process propagates positions from the position of the next scheduled thruster-burn to a position corresponding to a maximum elapsed time T after the next scheduled thruster-burn. Then, the process calculates a set of inequalities of equation (15) from a time of the next scheduled thruster-burn to the maximum elapsed time T, and the process goes to step 906. For example, the maximum elapsed time may be 48 hours and the time increment may be one minute. Thus, for each minute increment, the process determines a planned position of the space-vehicle, and calculates all the inequalities of equation (15).

In step 906, the process maps half-spaces in real-space corresponding to the inequalities into points in dual-space, and goes to step 908. In step 908, the process forms a convex hull of all points in dual space and identifies points on the convex hull, and the process goes to step 910. The process may add additional inequalities that correspond to a maximum deviation of a position of the space-vehicle from the planned position to simplify the convex hull. In step 910, the identified points on the convex hull are mapped from dual-space into identified half-spaces in real-space that define a basket of positions from which the next scheduled thruster-burn will result in passive-safety, and the process goes to step 912.

In step 912, the process acquires a current detected position and velocity of the space-vehicle relative to the resident-space-object, and goes to step 914. The detected position and velocity may be obtained from sensors onboard the space-vehicle or position and velocity detection equipment from ground-station equipment. In step 914, the process propagates the detected position and velocity forward to the time of the scheduled thruster-burn, and determines if all the inequalities corresponding to the identified half-spaces are satisfied. If all the inequalities are satisfied, the process goes to step 916. If any inequality is not satisfied, the process goes to step 918. In step 918, the process determines whether the scheduled thruster-burn time has arrived. If the scheduled thruster-burn time has arrived, the process goes to step 922. If the scheduled thruster-burn time has not arrived, the process goes to step 920. In step 920, the process outputs a thruster-burn warning signal, and returns to step 912. In step 922, the process outputs a thruster-burn reject signal, and the process goes to step 928 and ends. In step 916, the process determines whether the scheduled thruster-burn time has arrived. If the scheduled thruster-burn time has arrived, the process goes to step 924. If the scheduled thruster-burn time has not arrived, the process returns to step 912.

In step 924, the process executes the scheduled thruster burn and goes to step 926. In step 926, the process determines whether the rendezvous operation has completed. The rendezvous operation completion may be indicated by a signal from a user, for example, or by the absence of any further thruster-burns in the rendezvous plan. If the rendezvous operation has completed, the process goes to step 928 and ends. If the rendezvous operation has not completed, the process returns to step 902.

While the invention has been described in conjunction with exemplary embodiments, these embodiments should be viewed as illustrative, not limiting. Various modifications, substitutes, or the like are possible within the spirit and scope of the invention.

What is claimed is:

1. A space rendezvous control apparatus for a space-vehicle rendezvousing with a resident-space-object in a real-space comprising:
a detected position of the space-vehicle;
a nominal position of the space-vehicle of a next scheduled thruster-burn;
a keep-out-zone of the resident-space-object;
a plurality of first half-space boundary conditions determined based on the keep-out-zone, and the nominal position; and
a controller that generates a propagated position of the space-vehicle by propagating the detected position, and generates a signal relating to the next scheduled thruster-burn if the propagated position of the space-vehicle does not satisfy one or more of the first half-space boundary conditions.

2. The apparatus of claim 1, further comprising:
a plurality of second half-space boundary conditions, each second half-space boundary condition corresponding to a time after the next scheduled thruster-burn, wherein the controller calculates the second half-space boundary conditions based on a nominal position of the space-vehicle for the time corresponding to each second half-space boundary condition.

3. The apparatus of claim 2, wherein the controller selects first half-space boundary conditions from the second half-space boundary conditions by removing redundant second half-space boundary conditions.

4. The apparatus of claim 2, further comprising a plurality of second half-spaces in the real-space, each of the second half-spaces corresponding to one of the second half-space boundary conditions, wherein the controller maps the second half-spaces in the real-space as points in a dual-space.

5. The apparatus of claim 4, wherein the controller identifies points in dual-space that are on a convex hull of all points in the dual-space, and selects, as the first half-space boundary conditions, second half-space boundary conditions that correspond to the identified points in the dual-space.

6. The apparatus of claim 2, further comprising a thruster-burn vector associated with the next scheduled thruster-burn, each second half-space boundary condition being calculated based on the thruster-burn vector.

7. The apparatus of claim 2, wherein a maximum error of a position and a maximum error of a velocity of the space-vehicle are set to specific values and the second half-space boundary conditions are calculated based on the maximum error of the position and the maximum error of the velocity of the space-vehicle.

8. The apparatus of claim 1, wherein the first half-space boundary conditions are determined based on either a nominal position of the space-vehicle resulting from a re-planned scheduled thruster-burn, or a nominal position of the space-vehicle resulting from a prior scheduled thruster-burn that was not re-planned.

9. The apparatus of claim 1, wherein the apparatus is disposed in a ground-station or in the space-vehicle.

10. The apparatus of claim 2, further comprising:
means for calculating a second half-space boundary condition;
means for mapping the second half-space boundary conditions from the real-space to a dual-space;
means for identifying points in the dual-space that are on a convex hull of all points in the dual-space;
means for selecting the second half-space boundary conditions that correspond to the identified points as the first half-space boundary conditions;
means for checking whether a position of the space-vehicle obtained based on the detected position satisfies the first half-space boundary conditions; and
means for outputting a signal that relates to the next scheduled thruster-burn if any of the first half-space boundary conditions are not satisfied.

11. A method for controlling a space-vehicle to rendezvous with a resident-space-object in real-space comprising:
receiving a detected position of the space-vehicle;
receiving a nominal position of the space-vehicle of a next scheduled thruster-burn;
receiving a keep-out-zone of the resident-space-object;
calculating a plurality of first half-space boundary conditions based on the keep-out-zone and the nominal position;
propagating the detected position to obtain a propagated position of the space-vehicle; and
generating a signal that relates to the next scheduled thruster-burn if the propagated position of the space-vehicle does not satisfy one or more of the first half-space boundary conditions.

12. The method of claim 11, further comprising calculating a plurality of second half-space boundary conditions, each second half-space boundary condition corresponding to a time after the next scheduled thruster-burn, wherein the second half-space boundary conditions are calculated based on a nominal position of the space-vehicle for the time corresponding to each second half-space boundary condition.

13. The method of claim 12, further comprising selecting the first half-space boundary conditions by removing redundant second half-space boundary conditions.

14. The method of claim 12, further comprising mapping a plurality of second half-spaces in the real-space into points in a dual-space, each of the second half-spaces corresponding to one of the second half-space boundary conditions.

15. The method of claim 14, further comprising:
forming a convex hull of all points in the dual-space;
identifying points in the dual-space on the convex hull; and
selecting, as the first half-space boundary conditions, second half-space boundary conditions that correspond to the identified points in the dual-space.

16. The method of claim 11, further comprising:
checking if a position of the space-vehicle satisfies all the first half-space boundary conditions;
checking if a time of the next scheduled thruster-burn has arrived; and
outputting a signal that rejects the next scheduled thruster-burn if the time of the next scheduled thruster-burn has arrived and if any of the first half-space boundary conditions are not satisfied.

17. The method of claim 12, further comprising calculating the second half-space boundary conditions based on a thruster-burn vector associated with a next scheduled thruster-burn.

18. The method of claim 12, wherein a maximum error of a position and a maximum error of a velocity of the space-vehicle are set to specific values and the second half-space boundary conditions are calculated based on the maximum error of the position and the maximum error of the velocity of the space-vehicle.

19. The method of claim 11, further comprising determining the first half-space boundary conditions based on either a nominal position of the space-vehicle resulting from a re-planned scheduled thruster-burn, or a nominal position of the space-vehicle resulting from a prior scheduled thruster-burn that was not re-planned.

20. A space rendezvous system comprising:
a resident-space-vehicle;
a space-vehicle;
a detected position of the space-vehicle;
a nominal position of the space-vehicle of the next scheduled thruster-burn;
a keep-out-zone of the resident-space-object;
a plurality of first half-space boundary conditions determined based on the keep-out-zone, and the nominal position; and
a controller that generates a propagated position of the space-vehicle by propagating the detected position, and generates a signal that relates to the next scheduled thruster-burn if the propagated position of the space-vehicle does not satisfy one or more of the first half-space boundary conditions.
